(19) United States
(12) Patent Application Publication
(10) Pub. No.: US 2015/0181681 A1
(43) Pub. Date: Jun. 25, 2015

(54) OBSTACLE LIGHTING SYSTEM, METHOD FOR CONTROLLING AN OBSTACLE LIGHTING DEVICE

(71) Applicant: Orga Holding B.V., Schiedam (NL)

(72) Inventors: Thomas Leeuwangh, Schiedam (NL); Jan-Willem Deé, Schiedam (NL)

(21) Appl. No.: 14/407,160

(22) PCT Filed: Jun. 6, 2013
(86) PCT No.: PCT/NL2013/050400

§ 371 Date: Dec. 11, 2014

(30) Foreign Application Priority Data
Jun. 12, 2012 (NL) 2008987

(51) Int. Cl. H05B 37/02

(52) U.S. Cl. CPC H05B 37/0281

(57) ABSTRACT

Method for controlling power to be supplied to an obstacle lighting device for emitting light in flashes, wherein the obstacle lighting device comprises a lantern with a housing and at least one light emitting element arranged in the housing; wherein the method comprises providing a control signal to control the power to be supplied to the obstacle lighting device, such that the power to be supplied varies for flashes of different time lengths.

This application is a U.S. National Phase of International Application No. PCT/NL2013/050400, filed Jun. 6, 2013, which claims priority to The Netherlands Patent Application No. 2008987, filed Jun. 12, 2012, the disclosures of which are incorporated by reference herein.

The invention relates to an obstacle lighting device emitting light in flashes.

Obstacle lighting devices emitting flashing light are widely used in various signaling applications, such as in aviation, marine navigation or land transportation. For example, obstacle lighting devices may be provided on buildings, towers, wind turbines, offshore installations, etc. Obstacle lighting devices may be used as aids to navigation, as well in marine as in aviation applications.

The obstacle lighting device emits light in flashes, of which each flash has a predetermined time length. During the predetermined time of the flash, power is supplied to the obstacle lighting device to generate light and thus to emit the flashing light. Power can be provided by a battery system and/or a grid connection. A battery system may be a primary power source or may be a back-up power source. In case the battery system is the primary power source, for operational reasons, a second battery system is provided as a backup system.

Flashes can be emitted in various patterns, regular or irregular. For flashes that are emitted in a regular pattern, each subsequent flash has the same predetermined time length. For flashes that are emitted in an irregular pattern, the time length of subsequent flashes varies, e.g. a long flash may be followed by a number of short flashes. Such an irregular pattern may be repeated, but may also be followed by another regular or irregular pattern. The pause time between the flashes may be regular or irregular as well.

For a flashing light, the observed intensity as perceived by the human eye of a single flash is defined as “effective intensity”. In human observation, the visibility of flashing light sources varies depending on the duration and waveform of flashes for the same physical energy and spectrum of the flashes. To take into account such visual effects, the “effective intensity” is defined.

The effective intensity can be calculated using different calculation methods, such as the Blondel-Rey method, or the Schmidt-Clausen method, or the Allard method or modifications thereof or any other method. The calculation method is usually prescribed by the rules and/or regulations for the respective obstacle lighting devices. The effective intensity is a function of at least the instantaneous intensity and the time length of the flash, wherein the instantaneous intensity is considered to be the actual emitted intensity of the light source. For example, the effective intensity Iₑ can be calculated with the following formula:

$${I}_{eff} = \frac{{\int }_{{t}_{1}}^{{t}_{2}} I ( t ) d t}{a + ( {t}_{2} - {t}_{1} )} ,$$

according to the Blondel-Rey equation, wherein I(t) is the instantaneous intensity and a is a visual time constant, usually 0.2 sec.

The minimum effective intensity of a flash is usually prescribed in rules and regulations for the respective obstacle lighting devices.

A drawback of the present flashing lights is that the effective intensity varies per flash for flashes of different length, which may influence the energy consumption and/or the lifetime of the flashing lights. Also, the effective intensity may be higher than required by the rules and/or regulations.

Publication U.S. Pat. No. 3,541,388 discloses a method for maintaining the effective intensity from a flashing light source at a substantially constant value at reduced voltage associated with the end of battery life. In the Blondel-Rey equation, the intensity-function is known, due to measurement of the battery voltage, as well as the effective intensity value. The time length of the flash is the variable parameter that is adjusted to keep the effective intensity constant.

Publication U.S. Pat. No. 7,629,601 discloses a LED flash light system to replace a Xenon flash light system and to give the same effective intensity as the Xenon light system. The current is detected and in the Blondel-Rey equation, the flash duration is adjusted to provide the desired level of effective intensity.

As illustrated by e.g. U.S. Pat. No. 3,541,388 or U.S. Pat. No. 7,629,601, in conventional lighting devices emitting flashing light, the power is measured and supplied as a known value to the Blondel-Rey equation, while the flash duration is a variable to provide the desired effective intensity. In particular for flash patterns with flashes of different length, for example a flash pattern comprising long and short flashes, using such a method for controlling the effective intensity, may provide a too large variation in flashing lengths and/or a too large variation in effective intensity.

An object of the invention is to provide for a method and/or device that obviates at least one of the above mentioned drawbacks.

Thereto, the invention provides for a method for controlling power to be supplied to an obstacle lighting device for emitting light in flashes, wherein the obstacle lighting device comprises a housing and at least one light emitting element arranged in the housing; wherein the method comprises providing a control signal to set the power to be supplied to the obstacle lighting device, such that the power to be supplied is adapted for flashes of different time lengths, such as long and short flashes.

By adapting the power to be supplied per flash, the instantaneous intensity of the flash varies and thus the effective intensity varies. In the Blondel-Rey equation, the duration of the flash and the effective intensity are treated as known parameters, i.e. the value of these parameters is predetermined. Of course, other formula may be used to calculate the effective intensity. For example, the minimum effective intensity and/or the duration of the flash and/or tolerances thereof are known from e.g. rules and/or regulations. According to the invention, the instantaneous intensity, and thus the power to be supplied, is the variable to make the Blondel-Rey equation fit. This is contrary to the prior art, where the power is treated as a known variable.

The light emitting element can be an LED-element, but can equally well be a conventional incandescent lamp. Indeed for incandescent lamps, the power to be supplied can be a controllable variable. In addition, the voltage may be controlled as well.

Preferably, the desired effective intensity is known, e.g. from the rules and/or regulations and the power to be supplied is varied depending on the desired effective intensity. Per emitted flash, the effective intensity can be adjusted. More preferably, the effective intensity of the emitted flashes of the obstacle lighting device is approximately the same for all flashes. The power to be supplied can be varied depending on the desired effective intensity such that the effective intensity for the emitted flashes is approximately equal.

For a flash pattern comprising flashes of different time lengths, such as long and short flashes, this means that, according to the method of the invention, less power is to be supplied for the long flashes than for the short flashes to provide for the same or similar effective intensity. This is contrary to the prior art, in which both for the long and the short flashes the same power is supplied to the flashing light. In a prior art method, the power to be supplied depends on the effective intensity of the short flashes and then the power is the same for all, long and short, flashes. This results in a larger than required effective intensity of the long flashes as well as that the effective intensity of the long and short flashes is different.

Providing less power for the long flashes causes a significant reduction in power consumption. In particular for systems for which the power is supplied by a battery system, this means that the reduced power consumption leads to a smaller battery pack, and a smaller back-up battery pack, which may significantly reduce power supply costs, battery costs, maintenance costs etc.

Advantageously, setting of the power to be supplied is a one-off setup, for example at the factory, prior to the first use of the obstacle lighting device. The setup may remain unchanged during the lifetime of the obstacle lighting device. Nevertheless, a light source, such as an LED light source, may deteriorate during its lifetime. Therefore, monitoring of the deterioration of the light source may be done. The setup of the power to be supplied may be amended during the lifetime of the light source when deterioration is detected and/or when deterioration is detected to exceed a predetermined value. For example, when deterioration is detected and/or the deterioration exceeds a predetermined value, the power setup may be amended to increase the value of the power setup to maintain the predetermined intensity, typically for both the long and the short flashes, while the power to be supplied remains, according to the invention, different for the long and the short flashes. However, a light source, such as an LED light source, may deteriorate relatively slow, so in practical circumstances, one may consider to omit the monitoring of the deterioration of the light source and to hold the one-off setup of the power to be supplied. Of course, monitoring of the light source regarding various aspects may be present.

In an embodiment a further obstacle lighting device is controlled such that the further obstacle lighting device emits light in flashes. Preferably, for the further obstacle lighting device, the effective intensity is provided and the power to be supplied is determined depending on the effective intensity. The control signal is then provided on the determined power to be supplied. More preferably, the power to be supplied is determined such that the effective intensity of the emitted flashes of a different time length of the further obstacle lighting device is approximately equal.

Advantageously, a further obstacle lighting device can be controlled such that the further obstacle lighting device emits light in flashes of different time length. Similarly, the power to be supplied to the further obstacle lighting can be set depending on a predetermined effective intensity, preferably, such that the effective intensity of the emitted flashes of the further obstacle lighting device is approximately equal.

The invention also relates to an obstacle lighting system comprising an obstacle lighting device having a housing and at least one light emitting element arranged in the housing, further comprising a control unit to set the power to be supplied to the obstacle lighting device such that the obstacle lighting device emits light in flashes, wherein the power to be supplied is adapted for flashes of different time lengths, such as long and short flashes.

The control unit is configured to set the power to be supplied to the multiple obstacle lighting devices, preferably in such a way that the obstacle lighting devices are controlled by the control unit in a similar way. Preferably, the control unit sets the power to be supplied for the multiple obstacle lighting devices in the same way such that the effective intensity of the multiple obstacle lighting devices is approximately equal per flash.

The control unit affects the power that is to be supplied to the obstacle lighting device. For example, during the duration of a flash less power may be supplied to the obstacle lighting device than would be done according to the prior art. Supplying less power to the obstacle lighting device may result in a more cost effective operation and/or in a longer life time of the lighting device.

The control unit can be inside the housing of the obstacle lighting device, or can be outside the housing of the obstacle lighting device. When the control unit is inside the housing of the obstacle lighting device, the control unit basically sets the obstacle lighting device it is comprised in. When the control unit is outside the housing of the obstacle lighting device, the control unit can set multiple obstacle lighting devices, in addition the control unit may also provide for synchronisation of the multiple obstacle lighting devices.

Further aspects of the invention are represented in the subclaims.

The invention will further be elucidated on the basis of exemplary embodiments which are represented in the drawings. The exemplary embodiments are given by way of non-limitative illustration of the invention.

In the drawings:

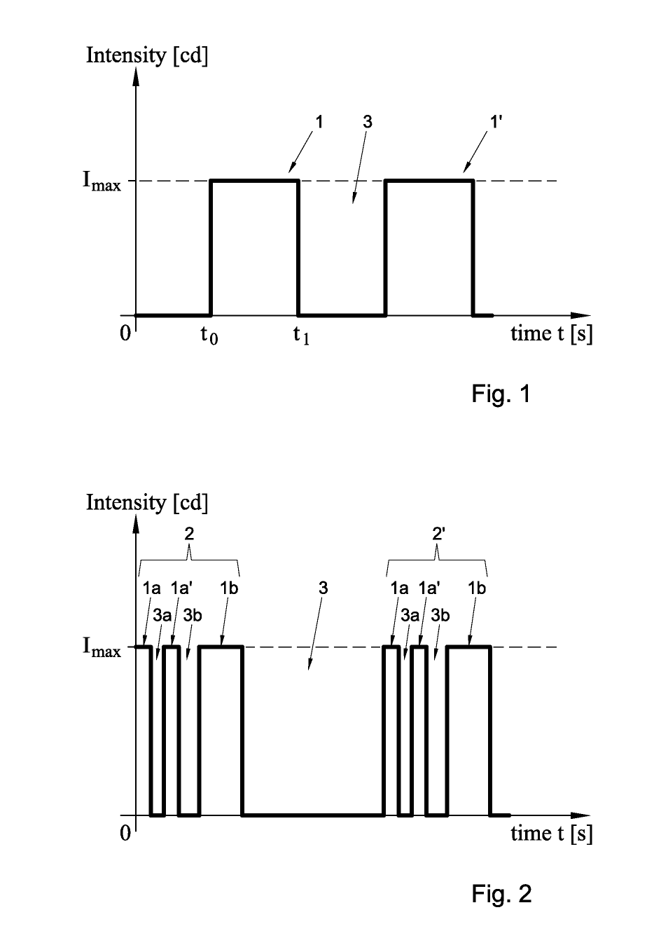

FIG. 1 shows a schematic view of a regular flash pattern according to the prior art;

FIG. 2 shows a schematic view of an irregular flash pattern according to the prior art;

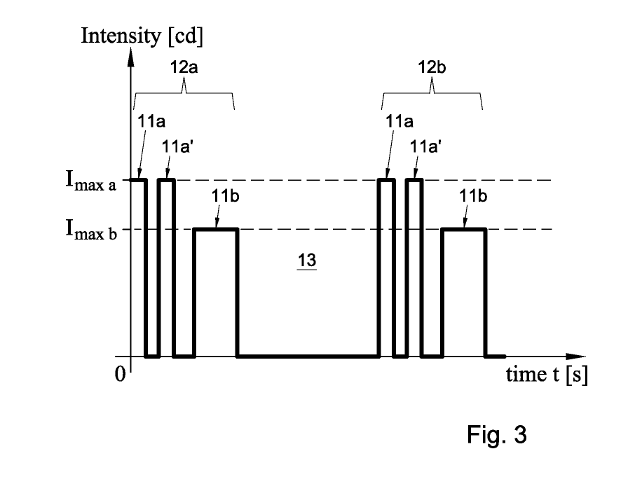

FIG. 3 shows a schematic view of an irregular flash pattern according to the invention;

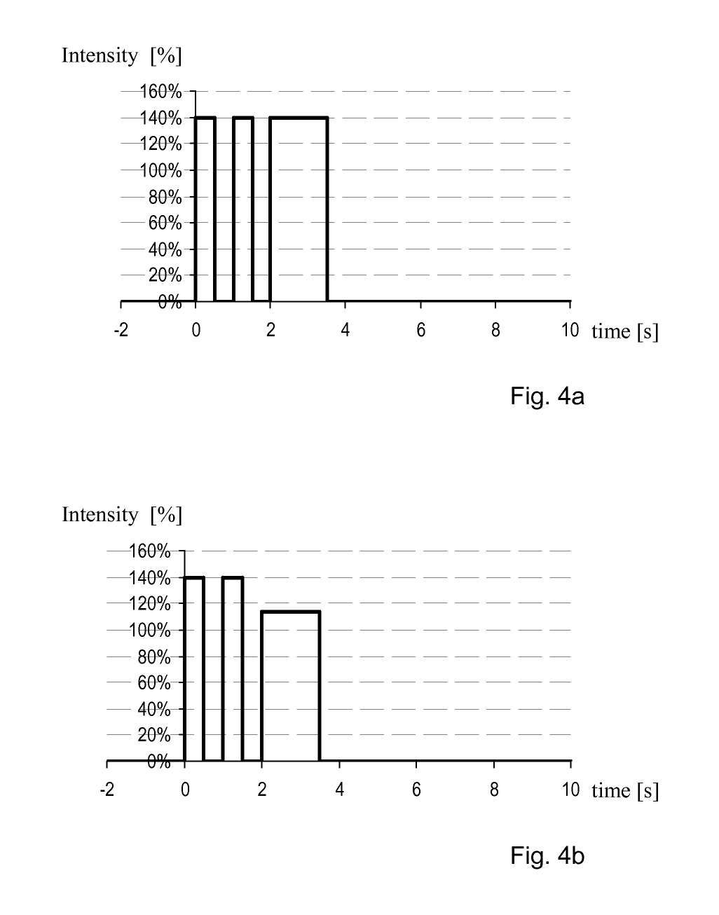

FIG. 4a shows an example of an irregular flash pattern Morse code U according to the prior art;

FIG. 4b shows an example of an irregular flash pattern Morse code U according to the invention;

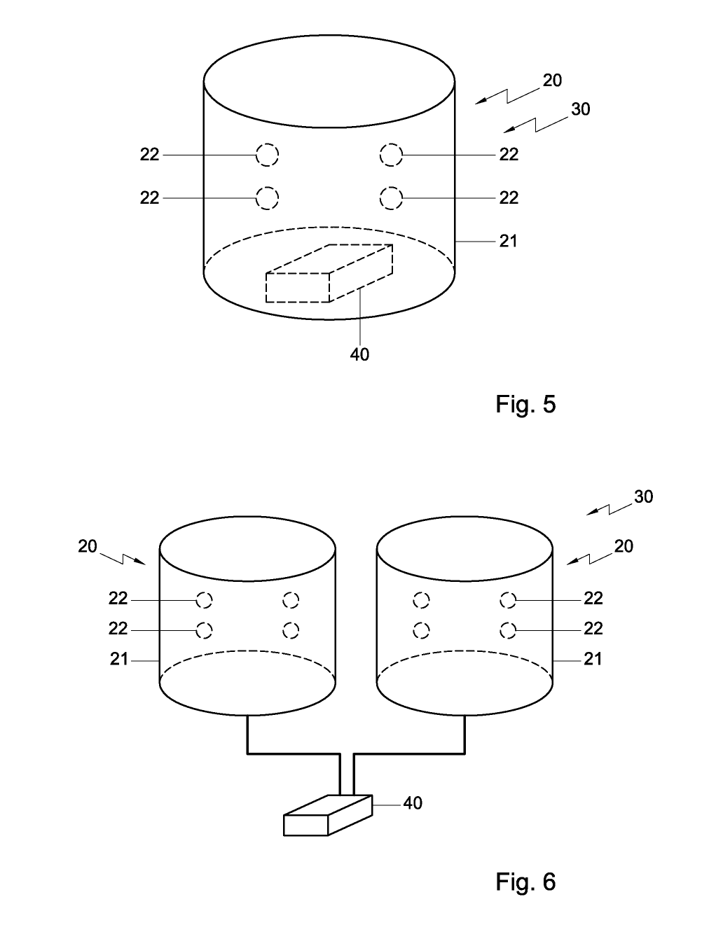

FIG. 5 shows a schematic view of a first embodiment of an obstacle lighting device according to the invention; and

FIG. 6 shows an obstacle lighting system comprising a second embodiment of an obstacle lighting device according to the invention.

It is noted that the figures are only schematic representations of embodiments of the invention that are given by way of non-limited example. In the figures, the same or corresponding parts are designated with the same reference numerals.

Obstacle lighting devices typically emit light in flashes. FIG. 1 shows a schematic view of an example of flashes 1, 1′. The flashes 1, 1′ are here repeated to form a train 2 with a pause 3 in-between in which no light is emitted. The train 2 of flashes 1, 1′ is in the embodiment of FIG. 1 a regular pattern, the length of the first flash 1 is approximately the same as the length of the second flash 1′. The flash 1, 1′ of FIG. 1 has a waveform of a simple block. Between time t₁ and time t₂ light is emitted with an instantaneous intensity of Iₘₐₓ. For a flash with a block form, the effective intensity Iₑ can be calculated with the following formula:

$${I}_{e} = \frac{{I}_{max} * ( {t}_{2} - {t}_{1} )}{a + ( {t}_{2} - {t}_{1} )} ,$$

wherein a is a visual time constant, usually 0.2 sec.

Of course, a flash can be emitted in various waveforms, such as a trapezoid, or a sine-squared waveform, or cycles of a sine-wave oscillation, or a peak waveform, or a triangle waveform, etc. Also, other methods are possible to calculate the effective intensity.

FIG. 2 shows an example of a train 2 of flashes 1a, 1a′, 1b that is repeated. A first train 2a is, after a pause 3, repeated by a second train 2b. Between the individual flashes 1a, 1a′, 1b also pauses 3a and 3b are provided in which no light is emitted. In this example, the train 2 and the train 2′ have the same flash pattern, but it is also possible that a first train of flashes is followed by a second, different train of flashes.

The train 2, 2′ of flashes comprises in this example two short flashes 1a, 1a′ and one long flash 1b. The flashes 1a, 1a′ have a different time length than the flash 1b. A flash pattern comprising flashes of different time lengths is indicated as an irregular flash pattern. As can be seen in FIG. 2, all emitted flashes are emitted with the same instantaneous maximum intensity Iₘₐₓ. The emitted instantaneous intensity is proportional to the power supplied to the obstacle lighting device. As can be seen in FIG. 1 and FIG. 2, according to the prior art, the power supplied for all flashes is the same to obtain the same instantaneous intensity. From the formula given above, it follows that the effective intensity I_{eb} of the long flash 1b is higher than the effective intensity Iₑₐ of the short flashes 1a.

To obviate this difference in effective intensity, according to the invention, the power to be supplied to the obstacle lighting device is varied per flash. In the example of FIG. 2, this may mean that the long flash 1b may be supplied with less power than the shorter flash 1a, as can be seen in FIG. 3 according to the invention. In FIG. 3, the long flash 11b is supplied with less power than the shorter flashes 11a, 11a′ such that the instantaneous maximum intensity of the long flash 11b I_{maxb} is lower than the instantaneous maximum intensity of the shorter flashes 11a, 11a′ Iₘₐₓₐ.

Preferably, the power to be supplied to the obstacle lighting device varies per flash such that the effective intensity for the emitted flashes is approximately the same. The effective intensity is usually prescribed by the rules and/or regulations the obstacle lighting device should comply with, which usually also prescribe the method to calculate the effective intensity. In the example of FIG. 3, depending on the actual values, the maximum intensities I_{maxb} and Iₘₐₓₐ may well be chosen such that the effective intensity of the flashes 11a and 11b is approximately the same.

The human observation of the intensity of the different flashes then may be approximately the same. In addition, power can be saved since, for longer flashes, the obstacle lighting device may be supplied with less power since the instantaneous intensity may be lower for longer flashes to achieve approximately the same effective intensity as the short flashes. Saving power may result in less costs, and also a reduction of the back-up equipment, such as a battery pack, may be obtained, thus resulting in a more economic operation of the obstacle lighting devices. In addition, by supplying less power to the obstacle lighting device for at least some of the flashes, the life time of the lighting device may increase.

FIG. 4 shows an example of a flash pattern, in FIG. 4a according to the prior art and in FIG. 4b according to the invention, with flashes of different time lengths. For example, an obstacle lighting device can emit flashes of light with the Morse code U. The Morse code U is defined as “short-short-long” with the following rules. The pause between each flash is the same length as a short flash. The long flash is defined as three times a short flash. The time of a single flash pattern of code U is fifteen seconds. This results in a short flash of 0,5 seconds, a long flash of 1,5 seconds and each pause is 0,5 seconds.

In the example, the effective intensity (Iₑ) is 100%. Using the Blondel-Rey method the instantaneous intensity (I), and thus the power to be supplied, for the short flash is:

$$I = \frac{{I}_{e} * ( a + ( {t}_{2} - {t}_{1} ) )}{( {t}_{2} - {t}_{1} )} = \frac{100 \% * ( 0.2 + 0.5 )}{0.5} = 140 \% .$$

In FIG. 4a the power supplied to the long and short flashes is the same 140%, as is done in prior art methods and devices. When supplying this 140% power to the lighting device during the long flash; the effective intensity of the long flash using the Blondel-Rey equation becomes:

$${I}_{e} = \frac{{I}_{max} * ( {t}_{2} - {t}_{1} )}{a + ( {t}_{2} - {t}_{1} )} = \frac{140 * 1.5}{0.2 + 1.5} = 123.5 \% .$$

Thus a 23,5% more power is supplied than strictly required. According to the invention, the power is adapted such that the effective intensity of the long and short flashes is approximately the same. This leads to a required power to be supplied, using the Blondel-Rey formulation:

$$I = \frac{{I}_{e} * ( a + ( {t}_{2} - {t}_{1} ) )}{( {t}_{2} - {t}_{1} )} = \frac{100 \% * ( 0.2 + 1.5 )}{1.5} = 113 \% .$$

According to the invention during a long flash 113% power can be supplied, contrary to the prior art in which 140% power is supplied. This is illustrated in FIG. 4b. The surface area under the graph line is the effective intensity, as well as the amount of energy powered to the light emitting element. When comparing FIG. 4b with FIG. 4a it can be seen that the power consumption in a conventional prior art setting is larger than the power consumption in a setting according to the invention.

This leads to a power reduction and thus a cost saving. In addition, when use is made of battery packs as a power supply, less batteries may be used. This may, in particular for offshore situations, for which the batteries may be relatively expensive, induce a significant cost saving.

FIG. 5 shows an embodiment of an obstacle lighting device 20 comprising a housing 21 and at least one light emitting element 22. The light emitting element 22 may be an optic with multiple light emitting units such as incandescent lights, xenon lights, LEDs etc. or may be a single light source as well.

According to the invention, an obstacle lighting system 30 comprises an obstacle lighting device 20 and a control unit 40. In the example shown in FIG. 4, the control unit 40 is accommodated in the housing 21, but the control unit 40 can also be accommodated outside the housing 21, as can be seen in FIG. 6.

When the control unit 40 is accommodated inside the housing 21, the obstacle lighting device 20 can be used as a stand-alone device.

When the control unit 40 is accommodated outside the housing 21, the obstacle lighting device 20 is a simple lantern, and the control unit 40 will likely control multiple obstacle lighting devices 20. The obstacle lighting system 30 comprises in this embodiment multiple obstacle lighting devices 20 that are controlled by the control unit 40.

Whether or not the control unit 40 is provided inside or outside the housing 21, parameters of the control unit 40 are set prior to the bringing the device 20 into use. Parameters can for example be: the required flash pattern, the required flash time, the required pause time, the required power to be supplied, etc. These parameters are usually calculated using software programs and/or determined using experimental set-ups during design and/or manufacturing, depending on the desired use of the lighting device 20, such as the desired effective intensity. When the parameters have been determined, they can be set into the control unit 40. The control unit 40 can be provided with software in which the parameters can be set and/or the control unit 40 can be provided with discrete electronic components the circuit of which determines the required settings. Usually, the control unit 40 is not arranged to perform any calculations itself, but calculations are done externally, during design and/or manufacturing and the control unit 40 is configured with the required parameter settings. However, in some situations, it may be advantageous to arrange the control unit 40 to perform calculations of the power to be supplied itself, e.g. when the operation mode is variable, depending on environmental influences or on regulatory influences. Usually the control unit is configured once with the predetermined effective intensity and required flash pattern, prior to the operation, preferably upon installation or during assembly. Of course, should during the operational life time of the obstacle lighting device the requirements change, e.g. the required flash pattern and/or the required predetermined effective intensity, the control unit can be reconfigured as well to comply with the amended regulations.

Many variants will be apparent to the skilled person in the art. The invention is not limited to the above shown examples. It is clear that the invention is explained using a simple block waveform of a flash and using a simple calculation method for calculating the effective intensity. The person skilled in the art will understand that other waveforms for the flashes are also possible and that other calculation methods for calculating the effective intensity are also possible. All variants are understood to be comprised within the scope of the invention defined in the following claims.

1. Method for controlling power to be supplied to an obstacle lighting device for emitting light in flashes, wherein the obstacle lighting device comprises a lantern with a housing and at least one light emitting element arranged in the housing; wherein the method comprises providing a control signal to set the power to be supplied to the obstacle lighting device, such that the power to be supplied is adapted for flashes of different time lengths, such as long and short flashes.

2. Method according to claim 1, further comprising providing a predetermined effective intensity, determining the power to be supplied to the obstacle lighting device depending on the predetermined effective intensity and providing the control signal depending on the determined power to be supplied.

3. Method according to claim 2, further comprising determining the power to be supplied to the obstacle lighting device such that the effective intensity of emitted flashes of the obstacle lighting device is approximately equal.

4. Method according to any of claims 1-3, further comprising controlling a further obstacle lighting device for emitting light in flashes.

5. Method according to claim 4, further comprising providing a predetermined effective intensity, determining the power to be supplied to the further obstacle lighting device depending on the predetermined effective intensity and providing the control signal depending on the determined power to be supplied.

6. Method according to claim 4 or 5, further comprising determining the power to be supplied to the further obstacle lighting device such that the effective intensity of emitted flashes of the further obstacle lighting device is approximately equal.

7. Obstacle lighting system comprising an obstacle lighting device having a housing and at least one light emitting element arranged in the housing, further comprising a control unit configured to set a power to be supplied to the obstacle lighting device such that the obstacle lighting device emits light in flashes, wherein the power to be supplied is adapted for flashes of different time lengths, such as long and short flashes.

8. Obstacle lighting system according to claim 7, wherein the control unit is configured to adapt the power to be supplied depending on a predetermined effective intensity per flash.

9. Obstacle lighting system according to claim 7 or 8, wherein the control unit is configured to adapt the power to be supplied depending on a predetermined effective intensity per flash such that the effective intensity of emitted flashes of different time lengths is approximately equal.

10. Obstacle lighting system according to any one of the claims 7-9, wherein the control unit is arranged inside the housing.

11. Obstacle lighting system according to any one of the claims 7-9, wherein the control unit is arranged outside the housing.

12. Obstacle lighting system according to claim 11, wherein the control unit is configured to set the power to be supplied to a further obstacle lighting device such that the further obstacle lighting device emits light in flashes of different time lengths.

13. Obstacle lighting system according to claim 12, wherein the control unit is configured to adapt the power to be supplied to the further obstacle lighting devices depending on a predetermined effective intensity per flash.

14. Obstacle lighting system according to any of claims 11-13, wherein the control unit is configured to adapt the power to be supplied to the further obstacle lighting device such that the effective intensity of emitted flashes of different time lengths is approximately equal.
